(19) United States
(12) Patent Application Publication
(10) Pub. No.: US 2026/0038823 A1
(43) Pub. Date: Feb. 5, 2026

(54) POSITIVE ELECTRODE ACTIVE MATERIAL, MANUFACTURING METHOD OF POSITIVE ELECTRODE ACTIVE MATERIAL, AND BATTERY

(71) Applicant: TOYOTA JIDOSHA KABUSHIKI KAISHA, Toyota-shi (JP)

(72) Inventor: Shin USHIRODA, Susono-shi (JP)

(73) Assignee: TOYOTA JIDOSHA KABUSHIKI KAISHA, Toyota-shi (JP)

(21) Appl. No.: 19/189,705

(22) Filed: Apr. 25, 2025

(30) Foreign Application Priority Data
Aug. 5, 2024 (JP) 2024-129145

(51) Int. Cl. H01M 4/485; C01G 53/56; H01M 4/04

(52) U.S. Cl. CPC H01M 4/485; C01G 53/56; H01M 4/0471; C01P 2002/50; C01P 2002/77; C01P 2006/40

(57) ABSTRACT

A positive electrode active material of the present disclosure includes an Na-containing oxide. The Na-containing oxide has a P2-type structure. An amount of Na included in the Na-containing oxide is 0.8 mol or more per mole of the Na-containing oxide. The Na-containing oxide includes, as constituent elements, at least: Na; at least one transition metal element among Mn, Ni, and Co; O; and at least one additive element among B, Al, and Mg.

### CROSS-REFERENCE TO RELATED APPLICATION

This application claims priority to Japanese Patent Application No. 2024-129145 filed on Aug. 5, 2024. The disclosure of the above-identified application, including the specification, drawings, and claims, is incorporated by reference herein in its entirety.

### BACKGROUND

### 1. Technical Field

The present application discloses a positive electrode active material, a manufacturing method of a positive electrode active material, and a battery.

### 2. Description of Related Art

Japanese Unexamined Patent Application Publication No. 2023-181098 (JP 2023-181098 A), Japanese Unexamined Patent Application Publication (Translation of PCT Application) No. 2022-504285 (JP 2022-504285 A), and Japanese Unexamined Patent Application Publication (Translation of PCT Application) No. 2022-549390 (JP 2022-549390 A) disclose positive electrode active materials that are used for sodium ion batteries and have a P2-type structure. Meanwhile, J. Am. Chem. Soc. 2020, 142, 5742-5750 discloses a technology that increases the amount of Na included in a positive electrode active material having a P2-type structure.

### SUMMARY

Conventional positive electrode active materials having a P2-type structure have room for improvement in terms of securing a high capacity while increasing the amount of Na.

The present application discloses the following aspects as means for solving the above challenge.

### Aspect 1

A positive electrode active material including an Na-containing oxide,
wherein the Na-containing oxide has a P2-type structure,
wherein an amount of Na included in the Na-containing oxide is 0.8 mol or more per mole of the Na-containing oxide, and
wherein the Na-containing oxide includes, as constituent elements, at least: Na;
at least one transition metal element among Mn, Ni, and Co; O; and
at least one additive element among B, Al, and Mg.

### Aspect 2

The positive electrode active material according to Aspect 1, wherein an amount of the additive element included in the Na-containing oxide may be more than 0 mol and 0.2 mol or less per mole of the Na-containing oxide.

### Aspect 3

The positive electrode active material according to Aspect 1 or 2, wherein the Na-containing oxide may include, as constituent elements, at least Na, Mn, Ni, O, and the additive element.

### Aspect 4

A manufacturing method of a positive electrode active material, comprising:
obtaining a solid mixture including a precursor, an Na source, and an additive element source; and
obtaining an Na-containing oxide having a P2-type structure by firing the solid mixture,
wherein the precursor includes at least one transition metal element among Mn, Ni, and Co, and
wherein the additive element source includes at least one additive element among B, Al, and Mg.

### Aspect 5

A battery having a positive electrode active material layer, an electrolyte layer, and a negative electrode active material layer, wherein the positive electrode active material layer includes the positive electrode active material according to any one of Aspects 1 to 3.

The positive electrode active material of this disclosure has an amount of Na included in the Na-containing oxide of 0.8 mol or more per mole of the Na-containing oxide, and at the same time has a high capacity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows one example of a flow of a manufacturing method of a positive electrode active material; and

FIG. 2 schematically shows one example of the configuration of a battery.

### DETAILED DESCRIPTION OF EMBODIMENTS

### 1. Positive Electrode Active Material

A positive electrode active material according to one embodiment includes an Na-containing oxide. The Na-containing oxide has a P2-type structure. An amount of Na included in the Na-containing oxide is 0.8 mol or more per mole of the Na-containing oxide. The Na-containing oxide includes, as constituent elements, at least: Na; at least one transition metal element among Mn, Ni, and Co; O; and at least one additive element among B, Al, and Mg.

### 1.1 Crystal Structure

The Na-containing oxide included in the positive electrode active material has at least the P2-type structure (which belongs to space group P63mc) as a crystal structure. In addition to having the P2-type structure, the Na-containing oxide may have a crystal structure other than the P2-type structure. Examples of crystal structures other than the P2-type structure include various crystal structures (a P3-type structure etc.) that are formed when Na is inserted into and desorbed from the P2-type structure. The Na-containing oxide may have the P2-type structure as a main phase. The crystal structure constituting the main phase of the Na-containing oxide can vary according to a charge-discharge state.

The size of crystallites of the Na-containing oxide included in the positive electrode active material is not particularly limited. In the Na-containing oxide, one crystallite may form one particle by itself, or one particle may be formed by a plurality of crystallites. In other words, the positive electrode active material according to one embodiment may be (1) a single-crystal particle that is present independently, (2) an aggregate (secondary particle) of a plurality of single-crystal particles, (3) a polycrystalline particle including a plurality of crystallites, or (4) an aggregate (secondary particle) of a plurality of polycrystalline particles. In particular, when the Na-containing oxide constitutes a polycrystalline particle, especially when it constitutes a spherical polycrystalline particle, even higher performance of the positive electrode active material is likely to be secured. The P2-type structure is a hexagonal system, in which the diffusion coefficient of Na ions is high and crystals tend to grow in one specific direction. Therefore, crystallites having the P2-type structure are typically ones of which the crystal growth direction is disproportionately one specific direction (e.g., plate-shaped ones). In this case, end portions (end portions in the aforementioned crystal growth direction) of the crystallites of the P2-type structure are likely to become inlets and outlets for intercalation. In other words, when the Na-containing oxide constitutes polycrystalline particles, effects can be expected such as an effect that the reaction resistance decreases as the numbers of inlets and outlets for intercalation included in one particle increase, an effect that the diffusion resistance decreases as the travel distance of sodium ions becomes shorter, and an effect that the amount of expansion and contraction of the particles as a whole during charge and discharge becomes smaller. For example, the diameter of the crystallites constituting the Na-containing oxide may be 0.1 μm or larger and 5.0 μm or smaller, 0.5 μm or larger and 4.0 μm or smaller, or 1.0 μm or larger and 3.0 μm or smaller. “Crystallites” and “the diameter of the crystallites” can be obtained by observing the external appearance etc. of the Na-containing oxide under a scanning electron microscope (SEM) or a transmission electron microscope (TEM). That is, when the Na-containing oxide is observed and one closed region surrounded by a crystal boundary is observed, this region is regarded as a “crystallite”. A maximum Feret's diameter of this crystallite is obtained, and the obtained diameter is regarded as “the diameter of the crystallite”. When the Na-containing oxide is formed by a single crystal, this single crystal itself can be called one crystallite, and a maximum Feret's diameter of this single crystal is “the diameter of the crystallite”. Alternatively, the diameter of the crystallite can be obtained by EBSD or XRD. For example, the diameter of the crystallite can be obtained from a half-value width of a diffraction line of an XRD pattern based on Scherrer's formula. When the diameter of the crystallite determined by any one of these methods is within the aforementioned range, the Na-containing oxide is likely to exhibit higher performance. The crystallites constituting the Na-containing oxide may have a first face that is exposed in a surface of the oxide, and this first face may be planar.

As described above, the crystallite of the Na-containing oxide having the P2-type structure tends to assume a plate-like shape. That is, the Na-containing oxide having the P2-type structure can be a plate-shaped particle as well as can be a spherical particle as small plate-shaped crystallites couple to one another. In other words, the Na-containing oxide as a whole may constitute a plate-shaped single-crystal particle or may constitute a spherical polycrystalline particle. The spherical polycrystalline particle has a plurality of crystallites on its surface. When the Na-containing oxide constitutes a spherical polycrystalline particle, the degree of flexion is reduced due to the spherical shape, which seems to reduce the sodium ion conduction resistance. Thus, for example, the battery is likely to have improved rate characteristics and a higher reversible capacity. In this application, “spherical particle” means a particle with a degree of circularity of 0.80 or higher. The degree of circularity of the particle may be 0.81 or higher, 0.82 or higher, 0.83 or higher, 0.84 or higher, 0.85 or higher, 0.86 or higher, 0.87 or higher, 0.88 or higher, 0.89 or higher, or 0.90 or higher. The degree of circularity of the particle is defined by 4πS/L². Here, S is an orthographic projection area of the particle, and L is the perimeter of an orthographic projection image of the particle. The degree of circularity of the particle can be obtained by observing the external appearance of the particle under a scanning electron microscope (SEM), a transmission electron microscope (TEM), or an optical microscope.

### 1.2 Chemical Composition

The Na-containing oxide included in the positive electrode active material includes, as constituent elements, at least: Na; at least one transition metal element among Mn, Ni, and Co; O; and at least one additive element among B, Al, and Mg. In particular, when the Na-containing oxide includes, as constituent elements, at least: Na; Mn; one or both of Ni and Co; O; and the additive element, especially when it includes, as constituent elements, at least Na, Mn, Ni, O, and the additive element, higher performance is likely to be obtained. Or also when the Na-containing oxide includes, as constituent elements, at least Na, Mn, Fe, O, and the additive element, higher performance is likely to be obtained.

The amount of Na included in the Na-containing oxide is 0.8 mol or more (0.8≤Na/O₂) per mole of the Na-containing oxide. In other words, the Na-containing oxide includes 0.4 mol or more Na relative to one mole of O. As far as the present inventor confirmed, when the amount of Na included in the Na-containing oxide is 0.8 mol or more per mole of the Na-containing oxide, a sufficient capacity cannot always be obtained despite the increased amount of Na. Possible explanations are: (1) When the amount of Na included in the Na-containing oxide increases, the Na—O bond becomes stronger, and the layer interval of Na layers in the P2-type structure becomes shorter, affecting insertion and desorption of Na. (2) During desorption of Na, the transition metal is eluted from a transition metal layer to an Na layer, and the crystallizability of the P2-type crystal structure degrades, affecting insertion and desorption of Na. As a solution, in this embodiment, the Na-containing oxide includes an additive element to be described later. Thus, the P2-type structure is stabilized and elution of the transition metal during desorption of Na etc. is mitigated, and consequently a high capacity is likely to be secured. In this embodiment, the upper limit of the amount of Na included in the Na-containing oxide is not particularly limited. The amount of Na included in the Na-containing oxide may be 1.4 mol or less, 1.3 mol or less, 1.2 mol or less, 1.1 mol or less, 1.0 mol or less, or 0.9 mol or less per mole of the Na-containing oxide.

The Na-containing oxide includes at least one or more among Mn, Ni, and Co as transition metal elements. In particular, when the Na-containing oxide includes, as transition metal elements, at least Mn and one or both of Ni and Co, especially when it includes at least Mn and Ni, higher performance is likely to be obtained. The amount of transition metal element included in the Na-containing oxide is not particularly limited as long as the P2-type structure can be maintained.

The Na-containing oxide includes, as additive elements, at least one or more among B, Al, and Mg. For example, the transition metal layers in the P2-type structure of the Na-containing oxide can be doped with these additive elements. In particular, when the Na-containing oxide includes, as additive elements, at least one or both of B and Al, especially when it includes at least Al, a higher capacity is likely to be secured. It is presumed that, since Mg, like Mn, Ni, etc., can bind with O to form an octahedral structure, the transition metal layers in the P2-type structure are more appropriately doped with Mg to more appropriately mitigate the aforementioned elution of the transition metal. Therefore, when the Na-containing oxide includes at least Mg as an additive element, excellent cycle characteristics as well as a high capacity are likely to be secured. The amount of additive element included in the Na-containing oxide is not particularly limited, and can be adjusted as appropriate according to target active material performance. In particular, when the amount of additive element included in the Na-containing oxide is more than 0 mol and 0.2 mol or less (0<additive element/O₂≤0.2) per mole of the Na-containing oxide, the above-described effects are likely to be obtained. The amount of additive element included in the Na-containing oxide may be more than 0 mol and less than 0.2 mol, or more than 0 mol and 0.1 mol or less, per mole of the Na-containing oxide.

The Na-containing oxide may have a chemical composition expressed by NaₐMnₓ₋ₚNi_{y-q}CO_{z-r}M_{p+q+r}O₂ (where 0.8≤a≤1.4, x+y+z=1.0, 0<p+q+r≤0.2, and M is at least one additive element among B, Al, and Mg). In this chemical composition, a is 0.8 or more and 1.4 or less, and may be 1.3 or less, 1.2 or less, 1.1 or less, or 1.0 or less. The value of x is 0 or more and may be 0.10 or more, 0.20 or more, 0.30 or more, 0.40 or more, 0.50 or more, or 0.60 or more, and is 1.00 or less and may be 0.90 or less, 0.80 or less, or 0.70 or less. The value of y is 0 or more and may be 0.10 or more, 0.20 or more, or 0.30 or more, and is 1.00 or less and may be 0.90 or less, 0.80 or less, 0.70 or less, 0.60 or less, 0.50 or less, or 0.40 or less. The value of z is 0 or more and 1.00 or less and may be 0.90 or less, 0.80 or less, 0.70 or less, 0.60 or less, 0.50 or less, 0.40 or less, 0.30 or less, 0.20 or less, or 0.10 or less. As described above, the additive element M has a function of stabilizing the P2-type structure (e.g., a function of mitigating elution of transition metal elements). In the above-described chemical composition, when p+q+r is more than 0 and 0.2 or less, an especially high capacity is likely to be secured. The value of p+q+r may be 0.01 or more, 0.02 or more, 0.03 or more, 0.04 or more, or 0.05 or more, and may be 0.19 or less, 0.17 or less, 0.15 or less, 0.13 or less, 0.11 or less, 0.10 or less, 0.09 or less, 0.07 or less, 0.06 or less, 0.05 or less, 0.04 or less, or 0.03 or less. While the composition ratio of O is almost 2, it is not limited to being exactly 2.0 and is variable. When the valence of the additive element M is +n in the above-described chemical composition, a relationship 3.0≤4(x−p)+2(y−q)+3(z−r)+n(p+q+r)≤3.5 may be met.

### 1.3 Others

The positive electrode active material according to one embodiment may be composed only of the above-described Na-containing oxide, or may be a combination of the above-described Na-containing oxide and another active material. The positive electrode active material according to one embodiment may be, for example, solid particles, or may be hollow particles, or may be particles with voids. While the size of the particles of the positive electrode active material is not particularly limited, a smaller size is considered to be more advantageous. For example, the mean particle diameter (D50) of the particles of the positive electrode active material may be 0.1 μm or larger and 10 μm or smaller, 1.0 μm or larger and 8.0 μm or smaller, or 2.0 μm or larger and 6.0 μm or smaller. The mean particle diameter (D50) is a particle diameter (D50, a median diameter) at an integrated value of 50% in a volume-based particle size distribution obtained by a laser diffraction scattering method.

### 2. Manufacturing Method of Positive Electrode Active Material

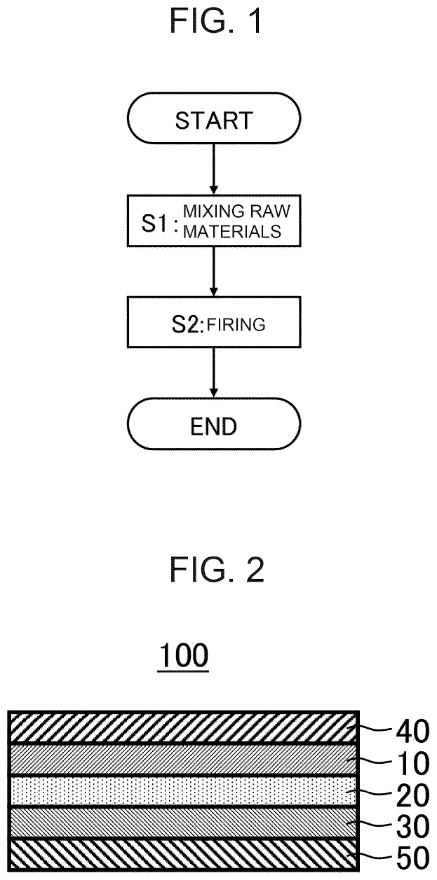

As shown in FIG. 1, a manufacturing method of the positive electrode active material according to one embodiment includes:
S1: obtaining a solid mixture including a precursor, an Na source, and an additive element source; and
S2: obtaining an Na-containing oxide having the P2-type structure by firing the solid mixture.

Here, the precursor includes at least one transition metal element among Mn, Ni, and Co, and the additive element source includes at least one additive element among B, Al, and Mg.

### 2.1 S1

In S1, the precursor may be a salt including at least one element among Mn, Ni, and Co. For example, the precursor may be at least one type among carbonate, sulfate, nitrate, and acetate. Or the precursor may be a compound other than salts. For example, the precursor may be a hydroxide. The precursor may be a hydrate. The precursor may be a combination of multiple types of compounds. The precursor may have various shapes. For example, the precursor may have a particulate shape, or may be a spherical particle as will be described later. The particle diameter of the particle formed by the precursor is not particularly limited. The composition of the precursor can be determined as appropriate so as to correspond to the composition of the Na-containing oxide that is a final product.

In S1, the precursor may be obtained as follows: Using an ion source that can form a precipitate with a transition metal ion in an aqueous solution, and a transition metal compound including at least one transition metal element among Mn, Ni, and Co, a precipitate as the precursor may be obtained by a coprecipitation method. Thus, a spherical particle as the precursor is likely to be obtained. “An ion source that can form a precipitate with a transition metal ion in an aqueous solution” may be, for example, at least one type selected from a sodium salt such as sodium carbonate or sodium nitrate, sodium hydroxide, and sodium oxide. The transition metal compound may be the aforementioned salt, hydroxide, etc. including at least one element among Mn, Ni, and Co. Specifically, in S1, a precipitate as the precursor may be obtained by turning each of the ion source and the transition metal compound into a solution and dripping and mixing together these solutions. In this case, as the solvent, for example, water is used. In this case, various sodium compounds can be used as the base, and an aqueous ammonia solution or the like may be added to adjust the basicity. In the case of the coprecipitation method, a precipitate as the precursor can be obtained by, for example, preparing an aqueous solution of the transition metal compound and an aqueous solution of sodium carbonate and dripping and mixing together these solutions. Or the precursor can also be obtained by a sol-gel method.

In S1, the Na source may be any compound that includes Na. The Na source may be, for example, an Na salt such as carbonate or sulfate, or may be an Na compound such as sodium oxide or sodium hydroxide. In one embodiment, the Na source may be sodium carbonate.

In S1, the additive element source may be any compound that includes at least one additive element among B, Al, and Mg. The additive element source may be, for example, a salt such as carbonate or sulfate, or may be a compound other than a salt, such as an oxide or a hydroxide. In one embodiment, the additive element source may be one or both of an oxide and a hydroxide.

In S1, at least the above-described precursor, Na source, and additive element source are mixed together to obtain a solid mixture including these. Means for mixing the precursor, the Na source, and the additive element source together is not particularly limited, and these may be manually mixed together using a mortar or the like, or may be mechanically mixed together using various mixing devices. In S1, the mixing ratio of the precursor, the Na source, and the additive element source can be determined as appropriate according to the composition of the Na-containing oxide that is the final product. For example, the amount of Na source to be mixed in relative to the precursor can be determined taking into account an amount of Na to be lost during the subsequent firing.

### 2.2 S2

In S2, the solid mixture obtained by S1 is fired to obtain an Na-containing oxide having the P2-type structure. That is, in this embodiment, the Na-containing oxide having the P2-type structure can be obtained by a so-called solid phase method. In S2, the solid mixture may be optionally molded and optionally subjected to preliminary firing before being subjected to main firing.

In S2, the molding method of the solid mixture is not particularly limited. The solid mixture may be molded into pellets by commonly known molding means.

In S2, the preliminary firing of the solid mixture may be performed at a temperature not higher than that of the main firing. For example, the preliminary firing can be performed at a temperature lower than 700° C. The preliminary firing time is not particularly limited. Or the preliminary firing may be skipped.

In S2, the main firing of the solid mixture may be performed at a temperature of, for example, 700° C. or higher and 1100° C. or lower. The temperature is preferably 800° C. or higher and 1000° C. or lower. When the main firing temperature is too low, the P2-type structure is not sufficiently formed, whereas when the main firing temperature is too high, a crystal structure other than the P2-type structure (e.g., an O3-type structure) is likely to form. The temperature raising condition from the preliminary firing temperature to the main firing temperature is not particularly limited. The main firing time is not particularly limited, either, and may be, for example, 30 minutes or longer and 10 hours or shorter. The main firing atmosphere is not particularly limited, either, and may be, for example, an oxygen-containing atmosphere, such as an atmosphere of ambient air, or an inert gas atmosphere.

### 3. Battery

A battery according to one embodiment has the above-described positive electrode active material of the disclosure. The positive electrode active material of the disclosure can be adopted as a positive electrode active material of a sodium ion battery, for example. As shown in FIG. 2, a battery 100 according to one embodiment has a positive electrode active material layer 10, an electrolyte layer 20, and a negative electrode active material layer 30, and the positive electrode active material layer 10 includes the positive electrode active material of the disclosure. The battery 100 can include a positive electrode current collector 40 and a negative electrode current collector 50. The battery 100 may be a solid-state battery or may be an aqueous battery. A solid battery refers to a battery which includes a solid electrolyte and in which presence of liquid is allowable. The battery 100 may be an all-solid-state battery that includes virtually no liquid. The configuration of the battery may be the same as the conventional one except that the positive electrode active material of the disclosure is adopted. Detailed description will be omitted here.

While one embodiment of the positive electrode active material etc. of the disclosure has been described above, various changes from the above-described embodiment can be made to the positive electrode active material etc. of the disclosure within such a range that no departure is made from the gist of the disclosure. In the following, the technology of the disclosure will be described in further detail while showing Examples, but the technology of the disclosure is not limited to the following Examples.

### 1. Production of Positive Electrode Active Material

### 1.1 Coprecipitation Synthesis of Precursor

MnSO₄·5H₂O and NiSO₄·6H₂O were weighed to a target composition ratio and dissolved in distilled water to a concentration of 1.2 mol/L to obtain a first liquid. In a separate container, Na₂CO₃ was dissolved in distilled water to a concentration of 1.2 mol/L to obtain a second liquid. Subsequently, to a reaction container with 1000 ml of pure water put therein beforehand, 500 mL of each of the first liquid and the second liquid was dripped at a speed of about 4 mL/min. After completion of the dripping, stirring was performed at room temperature, at a stirring speed of 150 rpm, for one hour. The resulting precipitate was washed with pure water and separated into a solid and a liquid by a centrifugal separator. The obtained precipitate was dried overnight at 120° C. and pulverized in a mortar, and then fine particles were removed by airflow classification. Thus, a precursor including Mn and Ni(Mn_{0.66}Ni_{0.34}CO₃) was obtained.

### 1.2 Mixing of Precursor, Na Source, and Additive Element Source

### 1.2.1 Examples 1-1 to 1-3

The above-described precursor, NaCO₃ as the Na source, and B₂O₃ as the additive element source were mixed together in a mortar to obtain a solid mixture.

### 1.2.2 Examples 2-1 to 2-3

The above-described precursor, NaCO₃ as the Na source, and Al(OH)₃ as the additive element source were mixed together in a mortar to obtain a solid mixture.

### 1.2.3 Examples 3-1 to 3-3

The above-described precursor, NaCO₃ as the Na source, and Mg(OH)₂ as the additive element source were mixed together in a mortar to obtain a solid mixture.

### 1.2.4 Comparative Examples 1 and 2

The above-described precursor and NaCO₃ as the Na source were mixed together in a mortar to obtain a solid mixture.

### 1.3 Firing of Solid Mixture

Firing of the solid mixture was performed inside an electric furnace using an alumina crucible in an atmosphere of ambient air (humidity 50% or higher). Specifically, the solid mixture was molded into pellets and then subjected to “first temperature raising step,” “preliminary firing step,” “second temperature raising step,” “main firing step,” and “in-furnace cooling step” as shown in Table 1 below. Thereafter, the fired object was taken out of the electric furnace at 250° C. and pulverized in a mortar in a dry atmosphere with a dew point of −30° C. or lower. Thus, an Na-containing oxide having the P2-type structure was obtained.

TABLE 1

| | | | | Temperature |
|---|---|---|---|---|
| | Start | End | | raising or |
| | temperature | temperature | Time | cooling speed |
| Step | (° C.) | (° C.) | (min) | (° C./min) |
| First temperature | 25 | 600 | 115 | 5 |
| raising step | | | | |
| Preliminary firing | 600 | 600 | 360 | 0 |
| step | | | | |
| Second temperature | 600 | 900 | 100 | 3 |
| raising step | | | | |
| Main firing step | 900 | 900 | 60 | 0 |
| In-furnace cooling | 900 | 250 | 130 | 5 |
| step | | | | |

### 2. Determination of Chemical Composition of Positive Electrode Active Material

The chemical compositions of the positive electrode active materials respectively of Examples 1-1 to 1-3, Examples 2-1 to 2-3, Examples 3-1 to 3-3, and Comparative Example 1 were determined by an ICP analysis. Table 2 below shows their respective chemical compositions.

TABLE 2

| | | Additive element |
|---|---|---|
| | Chemical composition | doping amount x |
| Example 1-1 | Na_{0.8}(Mn_{0.66}Ni_{0.34})₁₋ₓBₓO₂ | x = 0.02 |
| Example 1-2 | Na_{0.8}(Mn_{0.66}Ni_{0.34})₁₋ₓBₓO₂ | x = 0.06 |
| Example 1-3 | Na_{0.8}(Mn_{0.66}Ni_{0.34})₁₋ₓBₓO₂ | x = 0.10 |
| Example 2-1 | Na_{0.8}(Mn_{0.66}Ni_{0.34})₁₋ₓAlₓO₂ | x = 0.02 |
| Example 2-2 | Na_{0.8}(Mn_{0.66}Ni_{0.34})₁₋ₓAlₓO₂ | x = 0.06 |
| Example 2-3 | Na_{0.8}(Mn_{0.66}Ni_{0.34})₁₋ₓAlₓO₂ | x = 0.10 |
| Example 3-1 | Na_{0.8}(Mn_{0.66}Ni_{0.34})₁₋ₓMgₓO₂ | x = 0.06 |
| Example 3-2 | Na_{0.8}(Mn_{0.66}Ni_{0.34})₁₋ₓMgₓO₂ | x = 0.10 |
| Example 3-3 | Na_{0.8}(Mn_{0.66}Ni_{0.34})₁₋ₓMgₓO₂ | x = 0.20 |
| Comparative | Na_{0.8}Mn_{0.66}Ni_{0.34}O₂ | x = 0 |
| Example 1 | | |
| Comparative | Na_{0.7}Mn_{0.66}Ni_{0.34}O₂ | x = 0 |
| Example 2 | | |

### 3. Electrochemical Measurement

### 3.1 Discharge Capacity in First Cycle

The above-described positive electrode active material, PVdF as a binder, and carbon as a conduction aid were weighed to a mass ratio of positive electrode active material:PVdF:carbon=85:5:10, and were dispersedly mixed into N-methyl-2-pyrrolidone to obtain a slurry. This slurry was applied to an Al foil, and then this Al foil was pressed and vacuum-dried at 120° C. overnight to obtain a positive electrode. Using this positive electrode, a metal Na foil as a counter electrode, and a 1M NaPF₆PC solution as an electrolytic solution, a coin cell was produced. In a thermostatic bath held at 25° C., charge and discharge of the coin cell were performed in a voltage range of 2.0 to 4.5 V, at 0.1C rate, and the discharge capacity in the first cycle of charge and discharge was measured. The result is shown in Table 3 below.

TABLE 3

| | Additive | Additive element | Discharge |
|---|---|---|---|
| | element type | doping amount x | capacity (mAh/g) |
| Example 1-1 | B | 0.02 | 144.70 |
| Example 1-2 | B | 0.06 | 141.01 |
| Example 1-3 | B | 0.10 | 138.98 |
| Example 2-1 | Al | 0.02 | 153.73 |
| Example 2-2 | Al | 0.06 | 153.68 |
| Example 2-3 | Al | 0.10 | 140.33 |
| Example 3-1 | Mg | 0.06 | 139.52 |
| Example 3-2 | Mg | 0.10 | 143.27 |
| Example 3-3 | Mg | 0.20 | 122.84 |
| Comparative | None | 0 | 122.45 |
| Example 1 | | | |
| Comparative | None | 0 | 138.75 |
| Example 2 | | | |

From the result shown in Table 3, the following can be said. First, a look at the result of the case where doping of an additive element is not performed (Comparative Examples 1 and 2) shows that the positive electrode active material in which the amount of Na in the Na-containing oxide is 0.8 (Comparative Example 1) has a lower capacity than the positive electrode active material in which the amount of Na in the Na-containing oxide is 0.7 (Comparative Example 2). Possible explanations are: (1) When the amount of Na included in the Na-containing oxide increases, the Na—O bond becomes stronger and the layer interval of the Na layers in the P2-type structure becomes shorter, affecting insertion and desorption of Na. (2) During desorption of Na, the transition metal is eluted from a transition metal layer to an Na layer, and the crystallizability of the P2-type crystal structure degrades, affecting insertion and desorption of Na. On the other hand, the positive electrode active materials according to Examples 1-1 to 1-3, Examples 2-1 to 2-3, and Examples 3-1 to 3-3 have higher capacities than the positive electrode active material according to Comparative Example 1. This is presumably because, as the Na-containing oxide was doped with the predetermined additive element, the P2-type structure was stabilized to mitigate elution of the transition metal during desorption of Na etc., and consequently a higher capacity was secured.

### 3.2 Capacity Retention Rate

In a thermostatic bath held at 25° C., charge and discharge of the coin cell were performed in a voltage range of 2.0 to 4.5 V, at 0.1C rate, and with the discharge capacity in the first cycle as a reference (100%), the discharge capacity retention rates in the second cycle to the fifth cycle were measured. The result is shown in Tables 4 to 6 below.

TABLE 4

| | Comparative | | | |
|---|---|---|---|---|
| | Example 1 | Example 1-1 | Example 1-2 | Example 1-3 |
| First cycle | 100 | 100 | 100 | 100 |
| Second cycle | 96.2 | 94.1 | 96.3 | 95.5 |
| Third cycle | 90.3 | 87.2 | 91.7 | 90.0 |
| Fourth cycle | 84.2 | 81.9 | 86.9 | 84.8 |
| Fifth cycle | 78.9 | 78.0 | 82.7 | 80.3 |

TABLE 5

| | Comparative | | |
|---|---|---|---|
| | Example 1 | Example 2-2 | Example 2-3 |
| First cycle | 100 | 100 | 100 |
| Second cycle | 96.2 | 97.6 | 96.1 |
| Third cycle | 90.3 | 91.4 | 89.1 |
| Fourth cycle | 84.2 | 85.6 | 83.1 |
| Fifth cycle | 78.9 | 80.6 | 78.0 |

TABLE 6

| | Comparative | | | |
|---|---|---|---|---|
| | Example 1 | Example 3-1 | Example 3-2 | Example 3-3 |
| First cycle | 100 | 100 | 100 | 100 |
| Second cycle | 96.2 | 94.4 | 99.0 | 97.5 |
| Third cycle | 90.3 | 92.6 | 97.8 | 97.2 |
| Fourth cycle | 84.2 | 90.9 | 96.5 | 97.1 |
| Fifth cycle | 78.9 | 89.3 | 95.1 | 96.9 |

From the results shown in Tables 4 to 6, it can be seen that when the Na-containing oxide having the P2-type structure is doped with Mg, the cycle characteristics improve remarkably. It is presumed that, since Mg is likely to be more appropriately inserted into the transition metal layers in the P2-type structure compared with B and Al, elution of the transition metal to an Na layer during desorption of Na was appropriately mitigated, resulting in improved cycle characteristics.

### 4. Conclusion

While the positive electrode active materials having the specific chemical compositions have been illustrated in the above-described Examples, the chemical composition of the positive electrode active material is not limited to the above-described ones. In view of the results of the above-described Examples, a positive electrode active material meeting the following requirements (1) to (4) is considered to have a high capacity.
(1) The positive electrode active material includes an Na-containing oxide.
(2) The Na-containing oxide has a P2-type structure.
(3) The amount of Na included in the Na-containing oxide is 0.8 mol or more per mole of the Na-containing oxide.
(4) The Na-containing oxide includes, as constituent elements, at least: Na; at least one transition metal element among Mn, Ni, and Co; O; and at least one additive element among B, Al, and Mg.

What is claimed is:

1. A positive electrode active material comprising an Na-containing oxide,
wherein the Na-containing oxide has a P2-type structure,
wherein an amount of Na included in the Na-containing oxide is 0.8 mol or more per mole of the Na-containing oxide, and
wherein the Na-containing oxide includes, as constituent elements, at least: Na;
at least one transition metal element among Mn, Ni, and Co; O; and
at least one additive element among B, Al, and Mg.

2. The positive electrode active material according to claim 1, wherein an amount of the additive element included in the Na-containing oxide is more than 0 mol and 0.2 mol or less per mole of the Na-containing oxide.

3. The positive electrode active material according to claim 1, wherein the Na-containing oxide includes, as constituent elements, at least Na, Mn, Ni, O, and the additive element.

4. A manufacturing method of a positive electrode active material, comprising:
obtaining a solid mixture including a precursor, an Na source, and an additive element source; and
obtaining an Na-containing oxide having a P2-type structure by firing the solid mixture,
wherein the precursor includes at least one transition metal element among Mn, Ni, and Co, and
wherein the additive element source includes at least one additive element among B, Al, and Mg.

5. A battery, comprising a positive electrode active material layer, an electrolyte layer, and a negative electrode active material layer, wherein the positive electrode active material layer includes the positive electrode active material according to claim 1.
